(19) United States
(12) Patent Application Publication
(10) Pub. No.: US 2024/0001473 A1
(43) Pub. Date: Jan. 4, 2024

(54) ROBOT SYSTEM

(71) Applicant: FANUC CORPORATION, Yamanashi (JP)

(72) Inventors: Tomoyuki MOTOKADO, Yamanashi (JP); Toshihiko INOUE, Yamanashi (JP); Akihiro OIKAWA, Yamanashi (JP); Jingting CHEN, Yamanashi (JP)

(73) Assignee: FANUC CORPORATION, Yamanashi (JP)

(21) Appl. No.: 18/253,441

(22) PCT Filed: Dec. 16, 2021
(86) PCT No.: PCT/JP2021/046514

§ 371 Date: May 18, 2023

(30) Foreign Application Priority Data
Dec. 21, 2020 (JP) 2020-210937

(51) Int. Cl. B23K 9/095; B25J 11/00

(52) U.S. Cl. CPC B23K 9/0953; B25J 11/005

(57) ABSTRACT

A robot system, including a robot having a wrist mechanism including a flange that is rotatable about a rotation axis, a welding torch fixed to the flange by a torch bracket, and a welding sensor that is fixed with respect to the welding torch and that detects a weld line, where the welding sensor is disposed at a position between the flange and a fixed position at which the welding torch is fixed to the torch bracket, the welding sensor is capable of scanning a laser beam, and the welding torch includes a tubular torch body that is arranged so as to protrude toward a distal end side than the fixed position, and makes a wire protrude from a distal end of the tubular torch body by the tubular torch body curved at least twice.

### TECHNICAL FIELD

The present disclosure relates to a robot system.

### BACKGROUND

In general, an arc welding torch used in robots includes a curved torch body (for example, see Japanese Unexamined Patent Application, Publication No. 2009-34746). A wire passing through the interior of the torch body is curved in conformity to the curved shape of the torch body, and thus, it is possible to ensure stable contact between the wire and an inner surface of a power supply chip disposed at the distal end of the torch body, thereby stabilizing the generated arc.

In addition, there is a known real-time tracking technology in which the position and state of a weld line to be welded are detected in advance by means of laser beam scanning, and a robot performs welding along the detected weld line (for example, see Japanese Unexamined Patent Application, Publication No. H10-244367).

In Japanese Unexamined Patent Application, Publication No. H10-244367, a welding sensor is disposed in front of a torch body in a direction in which the torch body is moved by the robot, so as to be parallel to the torch body.

### SUMMARY

An aspect of the present disclosure is a robot system including: a robot including a wrist mechanism, the wrist mechanism including, at a distal end thereof, a flange that is rotatable about a rotation axis; a welding torch fixed to the flange by a torch bracket; and a welding sensor that is fixed with respect to the welding torch and that detects in advance a weld line to be welded by the welding torch, wherein the welding sensor is disposed at a position between the flange and a fixed position at which the welding torch is fixed to the torch bracket, the welding sensor is capable of scanning a laser beam in a direction intersecting the weld line along a plane parallel to the rotation axis, and the welding torch includes a tubular torch body that is arranged so as to protrude toward a distal end side than the fixed position, and makes a wire protrude from a distal end of the tubular torch body in a direction parallel to the rotation axis by the tubular torch body curved at least twice.

### BRIEF DESCRIPTION OF DRAWINGS

FIG. 1 is an overall configuration diagram showing a robot system according to an embodiment of the present disclosure.

FIG. 2 is a side view showing a wrist unit of a robot, a welding torch, and a welding sensor in the robot system in FIG. 1.

FIG. 3 is a plan view showing the wrist unit, the welding torch, and the welding sensor in FIG. 2.

FIG. 4 is a side view showing the wrist unit, the welding torch, and the welding sensor in a first modification of the robot system in FIG. 2.

FIG. 5 is a side view showing the wrist unit, the welding torch, and the welding sensor in a second modification of the robot system in FIG. 2.

FIG. 6 is a plan view showing the wrist unit, the welding torch, and the welding sensor in FIG. 5.

FIG. 7 is a front view showing the wrist unit, the welding torch, and the welding sensor in FIG. 5.

FIG. 8 is a bottom view for explaining a modification of the manner in which the welding torch and the welding sensor are attached to a flange in FIG. 5.

### DETAILED DESCRIPTION OF EMBODIMENT

In a case in which a welding sensor is disposed in the vicinity of the distal end of the torch body so as to be parallel thereto, there is a high possibility that the welding sensor interferes with a workpiece or the like when the torch body is brought close to the workpiece. In this case, by placing the welding sensor at a position where the welding sensor is sufficiently retracted from the distal end of the torch body, it is possible to reduce the interference around the distal end of the torch body.

However, when a torch body is curved in one direction, even if the welding sensor is disposed at a position where the welding sensor is sufficiently retracted from the distal end of the torch body, it is necessary to place the welding sensor so as to be significantly separated from the central axis of the torch body in order to scan a laser beam at a position adjacent to the torch body. As a result, the amount by which the welding sensor protrudes from the torch body becomes large, and there still be a high possibility that the welding sensor interferes with a surrounding device or the like.

A robot system 1 according to an embodiment of the present disclosure will be described below with reference to the drawings.

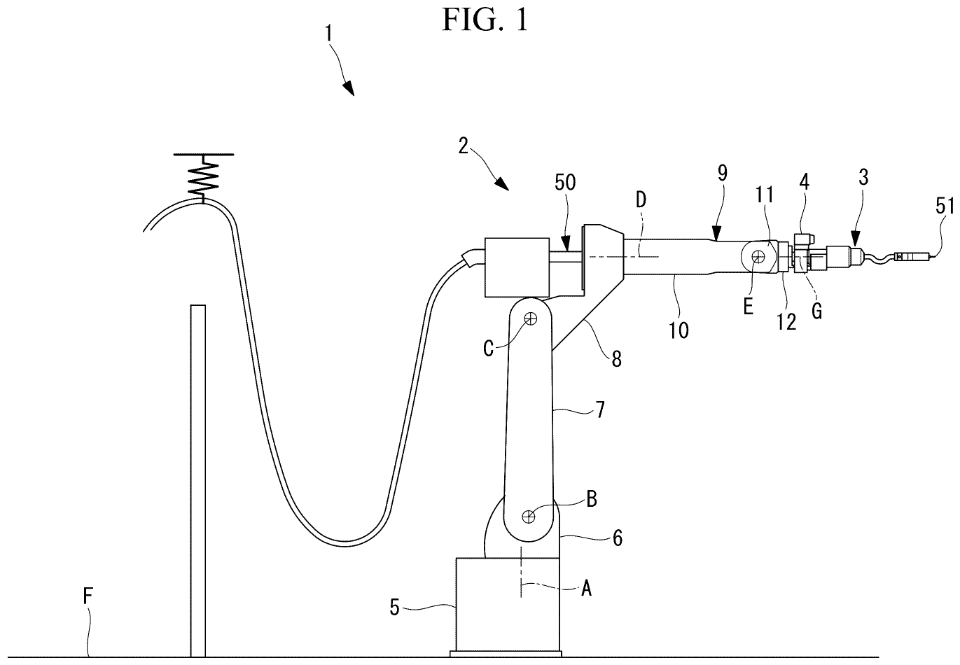

As shown in FIG. 1, the robot system 1 according to this embodiment includes: a robot 2; and a welding torch 3 and a welding sensor 4 that are attached to the distal end of a wrist mechanism 9 of the robot 2.

The robot 2 is, for example, a vertical six-axis articulated robot and includes: a base 5 that is installed on an installation surface F, such as a floor; a revolving drum 6 that is supported so as to be rotatable about a first axis A with respect to the base 5; and a first arm 7 that is supported so as to be rotatable about a second axis B with respect to the revolving drum 6. In addition, the robot 2 includes a second arm 8 that is supported so as to be rotatable with respect to the first arm 7 about a third axis C parallel to the second axis B, and a three-axis wrist unit (wrist mechanism) 9 that is disposed at the distal end of the second arm 8.

The wrist unit 9 includes a first wrist element 10 that is rotatable about a fourth axis D with respect to the second arm 8, and a second wrist element 11 that is rotatable with respect to the first wrist element 10 about a fifth axis E orthogonal to the fourth axis D. In addition, the wrist unit 9 includes a disk-shaped third wrist element (hereinafter referred to as “flange”) 12 that is rotatable about a sixth axis (rotation axis) G passing through an intersection of the fourth axis D and the fifth axis E and orthogonal to the fifth axis E.

An insulating adapter 13 composed of an electrically insulating material is fixed between the flange 12 and the welding torch 3. The insulating adapter 13 electrically insulates the flange 12 from the welding torch 3.

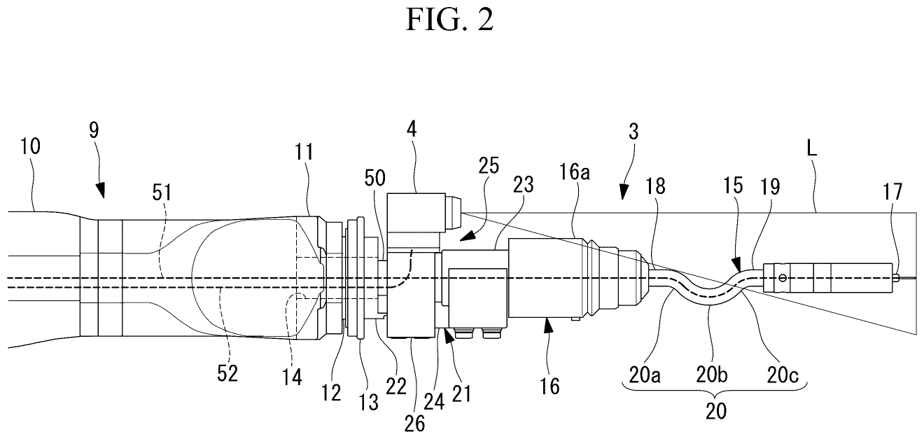

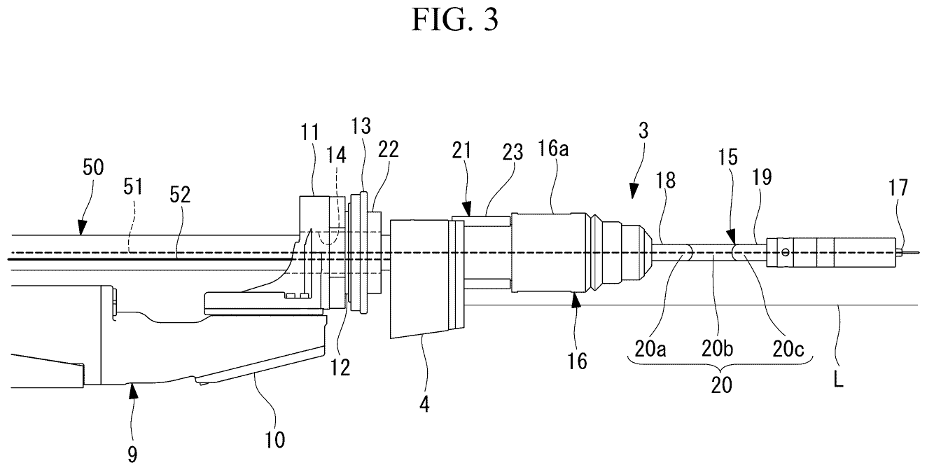

As indicated by a broken line in FIGS. 2 and 3, the second wrist element 11, the flange 12, and the insulating adapter 13 have, at a central position in a radial direction of the flange 12, a central hole (through-hole) 14 penetrating along the sixth axis G. A wire body 50 including a welding cable guided along the fourth axis D and connected to the welding torch 3, a wire 51, a shielding gas line, a sensor cable 52 connected to the welding sensor 4, and so forth penetrates through the central hole 14.

The welding torch 3 includes: a tubular torch body 15 that is disposed at the distal end and that is provided with an inner hole (not shown); and a neck holder 16 that supports a base end portion of the torch body 15. The torch body 15 is provided with a power supply chip 17 disposed in a distal end portion thereof. The welding cable connected to a welding power supply (not shown) is connected to the power supply chip 17, and the power supply chip 17 is provided with an inner hole (not shown) through which the wire 51 penetrates.

In addition, the torch body 15 includes: a base end portion 18 that is supported by the neck holder 16; a distal end portion 19 in which the power supply chip 17 is disposed; and a curved portion 20 that is disposed between the base end portion 18 and the distal end portion 19. The curved portion 20 includes: a first curved portion 20a that is curved in one direction from the base end portion 18; a second curved portion 20b that is curved in a direction opposite to the first curved portion 20a from the first curved portion 20a; and a third curved portion 20c that is further curved in a direction opposite to the second curved portion 20b from the second curved portion 20b. The torch body 15 is, as a result of being curved three times, formed in a shape in which both the base end portion 18 and the distal end portion 19 are coaxially arranged at positions aligned with the sixth axis G.

The wire 51 passes through the inner hole of the torch body 15, subsequently passes through the inner hole of the power supply chip 17, and thus protrudes from the distal end of the torch body 15 on the sixth axis G, in a direction along the sixth axis G. In addition, the wire 51 is curved in conformity to the curved portion 20 when passing through the inner hole of the torch body 15. Thus, when the wire 51 passes through the inner hole of the power supply chip 17, the wire 51 is pressed against an inner surface of the inner hole. With this configuration, the wire 51 and the welding cable are electrically connected to each other via the power supply chip 17 in a stable manner.

The neck holder 16 is provided with, for example, a shock sensor (not shown) for detecting contact between the distal end of the torch body 15 and a surrounding member, such as a workpiece. With this configuration, the neck holder 16 has a cylindrical outer surface shape having a larger diameter than the torch body 15.

The welding torch 3 is fixed to the flange 12 by means of a torch bracket 21, with the insulating adapter 13 interposed therebetween.

The torch bracket 21 includes: a fixed portion 22 that is fixed to the insulating adapter 13; a holding portion 23 that holds a base end portion (fixed position) 16a of the neck holder 16 of the welding torch 3, at a position separated from the insulating adapter 13 in a direction along the sixth axis G; and a connecting portion 24 that connects the fixed portion 22 and the holding portion 23. In this embodiment, the connecting portion 24 is disposed in a portion in the circumferential direction around the sixth axis G. With this configuration, a recessed portion 25 that is recessed radially inward is formed in a region in which the connecting portion 24 is not disposed between the welding torch 3 and the flange 12.

As shown in FIG. 3, the welding sensor 4 scans, at the front side of the torch body 15 in a direction in which the torch body 15 is moved by the robot 2, a laser beam L along a scanning plane intersecting the moving direction, and also detects reflected light of the laser beam L reflected at an object to be welded. With this configuration, it is possible to detect in advance, before welding is performed, the position and state of a weld joint (weld line: not shown) to be welded. Here, the state of the weld joint includes, for example, a groove width in butt welding, a gap in fillet welding, and the like.

The position and state of the weld joint detected by the welding sensor 4 are fed back to a controller (not shown) of the robot 2, whereby the welding position and welding conditions are corrected. With this configuration, it is possible to achieve high-quality welding even when the position and shape or the like of the weld joint vary.

In this embodiment, the welding sensor 4 is disposed between the insulating adapter 13 and the position at which the welding torch 3 is fixed to the torch bracket 21, and is fixed to the torch bracket 21 by means of a sensor bracket 26. With this configuration, the surface of the welding sensor 4 where the laser beam L is emitted and the light-receiving surface where the reflected light of the laser beam L enters are arranged closer to the flange 12 than the maximum diameter portion 16a of the neck holder 16 of the welding torch 3.

In addition, the welding sensor 4 is partially accommodated in the recessed portion 25 formed between the welding torch 3 and the flange 12, and is also positioned and oriented to scan the laser beam L along the scanning plane parallel to the sixth axis G. In other words, the welding sensor 4 is disposed at a position where the emitted laser beam L and the reflected light of the laser beam L returning from the object to be welded are not blocked by the welding torch 3, said position being as close as possible to the sixth axis G.

The operation of the thus-configured robot system 1 according to this embodiment will be described below.

With the robot system 1 according to this embodiment, the wire 51 penetrates through the central hole 14 provided in the second wrist element 11, the flange 12, and the insulating adapter 13, and is guided into the welding torch 3 that is fixed to the flange 12 with the insulating adapter 13 interposed therebetween. The wire 51 introduced into the welding torch 3 passes through the inner hole of the torch body 15 and the inner hole of the power supply chip 17, and protrudes from the distal end of the torch body 15.

In this case, with this embodiment, the torch body 15 of the welding torch 3 is curved three times; thus, it is possible to place the distal end of the torch body 15 on the sixth axis G and to make the wire 51 protrude along the sixth axis G. Because the wire 51 is curved while passing through the torch body 15, when the wire 51 passes through the inner hole of the power supply chip 17, the wire 51 is pressed against the inner surface of the inner hole, thereby enabling stable arc generation.

In addition, as a result of the wire 51 being made to protrude along the sixth axis G, it is possible to place the scanning plane of the laser beam L near the distal end of the welding torch 3, while retracting the welding sensor 4 from the distal end of the torch body 15 by a large amount to place the welding sensor 4 at a position close to the flange 12, in close proximity to the sixth axis G.

By retracting the welding sensor 4 from the distal end of the torch body 15 by a large amount, it is possible to reduce interference with a surrounding object around the distal end of the torch body 15, for example, in a case in which no other object is present around the welding torch 3 and the torch body 15 is inserted into a narrow space to perform welding. In addition, by bringing the welding sensor 4 close to the sixth axis G, there is an advantage in that it is possible to suppress the radially outward protrusion thereof in the vicinity of the flange 12, thereby suppressing interference around the wrist unit 9.

In particular, the torch bracket 21 that fixes the welding torch 3 to the insulating adapter 13 includes the connecting portion 24 only in a portion in the circumferential direction around the sixth axis G, and the recessed portion 25 is formed in a region in which the connecting portion 24 is not present. With this configuration, there is an advantage in that it is possible to accommodate a portion of the welding sensor 4 disposed between the welding torch 3 and the flange 12 in the recessed portion 25, and to further reduce the amount by which the welding sensor 4 protrudes radially outward from the sixth axis G.

In addition, by placing the welding sensor 4 at a position close to the flange 12, it is possible to configure the sensor bracket 26 for attachment of the welding sensor 4 to be small and lightweight. In other words, in a case in which the welding sensor 4 is disposed in the vicinity of the distal end of the torch body 15, the sensor bracket 26 to be fixed to the flange 12 or the torch bracket 21 becomes long and the weight thereof increases.

Because the rigidity is reduced if the sensor bracket 26 becomes long, the sensor bracket 26 is easily vibrated and the detection accuracy is reduced. In contrast, by bringing the welding sensor 4 close to the flange 12, there is an advantage in that it is possible to reduce the length and weight of the sensor bracket 26 to be fixed to the torch bracket 21, and to suppress the occurrence of vibrations even with a lower rigidity, thereby accurately detecting a weld line.

In addition, in this embodiment, the torch body 15 is curved three times; thus, the wire 51 protruding in a direction along the sixth axis G from the central hole 14 of the flange 12 toward the base end portion 18 of the torch body 15 is curved back onto the sixth axis G in the distal end portion 19 of the torch body 15. With this configuration, there is also an advantage in that it is possible to place the distal end of the wire 51, which is set as a tool center point serving as a reference for operation of the robot 2, on the sixth axis G, thereby facilitating the teaching work and control therefor.

In addition, because the welding sensor 4 is arranged so as to be retracted from the distal end of the torch body 15 by a large amount, welding fumes generated at the distal end of the torch body 15 hardly reach the welding sensor 4, and thus, it is possible to reduce the occurrence of a problem such as fouling of the welding sensor 4.

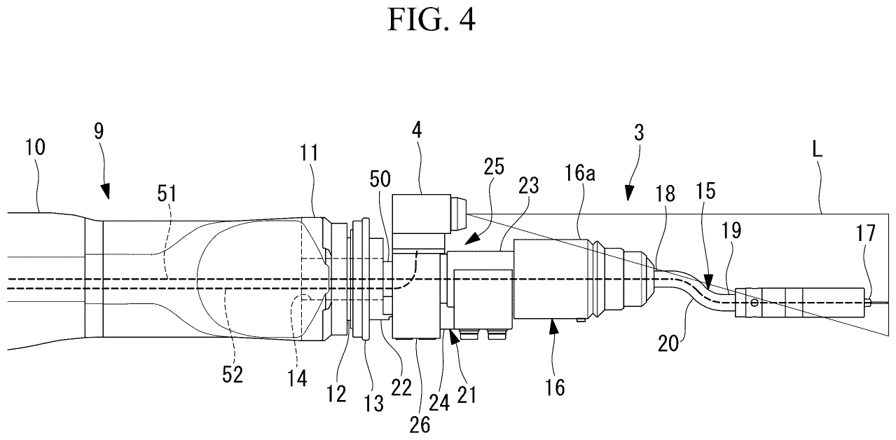

Note that, in this embodiment, the torch body 15 is curved three times to place the wire 51 on the sixth axis G at the distal end of the torch body 15. Alternatively, as shown in FIG. 4, the torch body 15 may be curved twice so that the wire 51 protrudes at a position parallel to the sixth axis G. With this configuration also, as in the abovementioned embodiment, it is possible to place the welding sensor 4 at a position where the welding sensor 4 is retracted to be closer to the flange 12 than the welding torch 3, and also in close proximity to the sixth axis G.

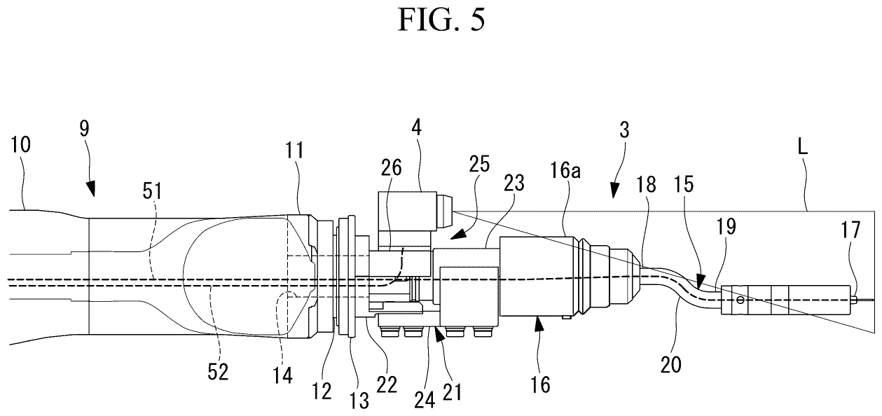

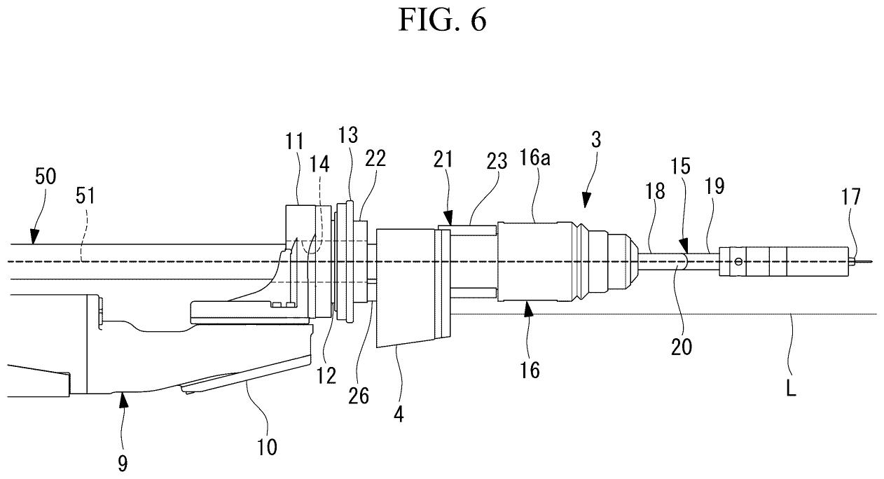

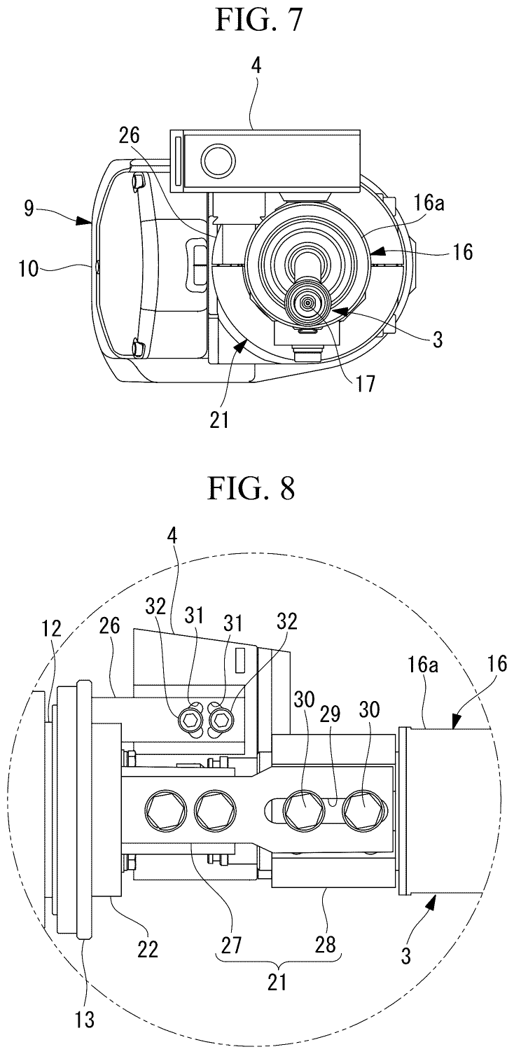

In addition, although the sensor bracket 26 is fixed to the torch bracket 21 that fixes the welding torch 3 to the flange 12 in this embodiment, alternatively, the torch bracket 21 and the sensor bracket 26 may be separately fixed to the flange 12. In an example shown in FIGS. 5 to 7, the torch bracket 21 is fixed using one half of the circumference around the central hole 14 of the flange 12, and the sensor bracket 26 is fixed using the other half of the circumference.

By separately fixing the torch bracket 21 and the sensor bracket 26 to the flange 12, it is possible to prevent an external force and vibrations applied to the torch bracket 21 from being transmitted to the welding sensor 4, and thus to more accurately detect a weld line.

In addition, although the vertical articulated robot has been illustrated as an example of the robot 2 in this embodiment, the type of the robot is not limited thereto, and any other type of robot may be employed.

In addition, as shown in FIG. 8, the torch bracket 21 may include: a first bracket 27 that is fixed to the flange 12 with the insulating adapter 13 interposed therebetween; and a second bracket 28 that is fixed to the welding torch 3. In addition, for example, the positions of the first bracket 27 and the second bracket 28 may be adjustable in a direction along the sixth axis G by means of a long hole 29 provided in one of the brackets, and bolts 30 that penetrate through the long hole 29 to be detachably fastened to the other bracket. In an example shown in FIG. 8, the long hole 29 is provided in the first bracket 27 and the bolts 30 are fastened to the second bracket 28; however, the configuration may be reversed. With this configuration, it is possible to adjust the distal end position of the torch body 15 in a direction along the sixth axis G.

In addition, as shown in FIG. 8, the welding sensor 4 may be attached to the sensor bracket 26 in such a manner that the angle thereof can be adjusted about an axis extending in a direction along the scanning plane. In the example shown in FIG. 8, the sensor bracket 26 is provided with an angle adjustment mechanism constituted of: long holes 31 extending in an arc shape around the axis; and bolts 32 that penetrate through the long holes 31 to be detachably fastened to the welding sensor 4. By adjusting the angle at which the welding sensor 4 is attached to the sensor bracket 26, it is possible to adjust the position of the scanning plane with respect to the wire 51.

1. A robot system comprising:
a robot including a wrist mechanism, the wrist mechanism including, at a distal end thereof, a flange that is rotatable about a rotation axis;
a welding torch fixed to the flange by a torch bracket; and
a welding sensor that is fixed with respect to the welding torch and that detects, in advance, a weld line to be welded by the welding torch,
wherein the welding sensor is disposed at a position between the flange and a fixed position at which the welding torch is fixed to the torch bracket, the welding sensor is configured to scan a laser beam in a direction intersecting the weld line along a plane parallel to the rotation axis, and
the welding torch includes a tubular torch body that is arranged so as to protrude toward a distal end side than the fixed position, and makes a wire protrude from a distal end of the tubular torch body in a direction parallel to the rotation axis by the tubular torch body curved at least twice.

2. The robot system according to claim 1, wherein the torch body is curved so that the wire protrudes, along the rotation axis, from the distal end of the torch body onto the rotation axis.

3. The robot system according to claim 1, further comprising a recessed portion that is provided between the flange and the fixed position and that is recessed radially inward about the rotation axis,
wherein the welding sensor is positioned so as to be partially accommodated in the recessed portion.

4. The robot system according to claim 1, wherein the welding sensor is fixed to the torch bracket.

5. The robot system according to claim 1, wherein the welding sensor is fixed to the flange by a sensor bracket separately from the torch bracket.
